(19) United States
(12) Patent Application Publication
(10) Pub. No.: US 2004/0238228 A1
(43) Pub. Date: Dec. 2, 2004

(54) Scale that provides a display of an individual's weight history on a remote computer

(76) Inventors: David S. Montague, Bellevue, WA (US); Joanne van Erp Montague, Bellevue, WA (US)

Correspondence Address: David S. Montague, 3605 130th AVE NE, Bellevue, WA, 98005, US

(21) Appl. No.: 10/449,897

(22) Filed: Jun. 2, 2003

(51) Int. Cl. G01G 19/22

(52) U.S. Cl. 177/25.13; 177/25.19; 340/666; 702/173

(57) ABSTRACT

A scale system that measures the weight of an individual, displays an individual's weight on the scale, automatically records the individual's weight and date and time of the measuring, and displays an individual's weight history on a remote computer. The system can display an individual's weight history on a remote computer system independent of measuring an individual's weight. The system includes the accumulation over time of an individual's weight data, either storing it locally for later transmission or transmitting it immediately to the remote computer. The system also includes automated weight data correction, and manual weight data correction that can be performed by a user. The system is not limited to one individual and can be used by more than one individual.

### CROSS-REFERENCE TO RELATED APPLICATIONS

U.S. Pat. No. 5,839,901 Karkanen Nov. 24, 1998

U.S. Pat. No. 5,886,302 Germanton, et al. Mar. 23, 1999

U.S. Pat. No. 6,038,465 Melton, Jr. Mar. 14, 2000

U.S. Pat. No. 6,416,471 Kumar, et al. Jul. 9, 2002

U.S. Pat. No. 6,538,215 Montagnino, et al. Mar. 25, 2003

### STATEMENT REGARDING FEDERALLY SPONSORED RESEARCH OR DEVELOPMENT

Not Applicable.

### REFERENCE TO SEQUENCE LISTING, A TABLE, OR A COMPUTER PROGRAM LISTING COMPACT DISK APPENDIX

Not Applicable.

### BACKGROUND OF THE INVENTION

Individuals interested in losing weight, maintaining a weight or gaining weight find that their weight fluctuates over time. These fluctuations can by caused by monthly cycles, changes in daily consumption of food, longer term changes in diet, changes in health, changes in exercise, and other unknown factors. Individuals attempting to lose weight, maintain weight, or gain weight who look at their weight on a day-by-day basis will not have a consistent weight that they can use to measure the success of their attempts. This invention allows an individual to measure his/her weight over time, and view and discount the cyclic fluctuations, and to observe trends in his/her weight over time.

### BRIEF SUMMARY OF THE INVENTION

An embodiment of this invention provides a scale that one or more individuals may use to weigh and display their current weights on the scale, and add that weight to an accumulation of weight measurements for the individual over time. These accumulations of weight measurements may then be viewed in graphic form on a remote computer as a profile for an individual's weight versus time, thus providing a view of the individual's long term and cyclic weight changes.

### BRIEF DESCRIPTION OF THE SEVERAL VIEWS OF THE DRAWING

FIG. 1 is a diagram of the scale system.

FIG. 2 is a diagram of the scale system showing the components of the scale system.

FIG. 3 is a diagram of an alternate configuration of the components of the scale system.

FIG. 4 is a state machine describing the operation of the scale portion of the scale system.

FIG. 5 is a flowchart of the weight display system of the remote computer.

### DETAILED DESCRIPTION OF THE INVENTION (OR DESCRIPTION OF THE PREFERRED EMBODIMENT)

The preferred embodiment of this invention consists of a scale that measures the weight of an individual, displays the individual's current weight for viewing, and transmits the individual's weight to a remote computer. The date and time of each measurement is accumulated with the weight measurement to make the weight history. The remote computer accumulates the weight history for each individual that uses the scale, and provides a means to display an individual's weight history.

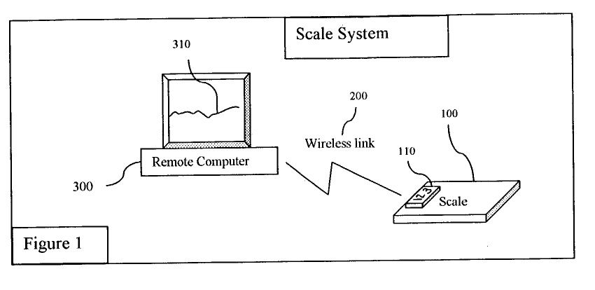

FIG. 1 is a high-level depiction of the scale system. Scale 100 measures an individual's weight, displays it via display 110, and transmits the weight measurement to the remote computer system via wireless link 200. Remote computer 300 receives the weight transmission and adds it to an accumulation of an individual's weights. Remote computer 300 displays accumulations of weight data 310.

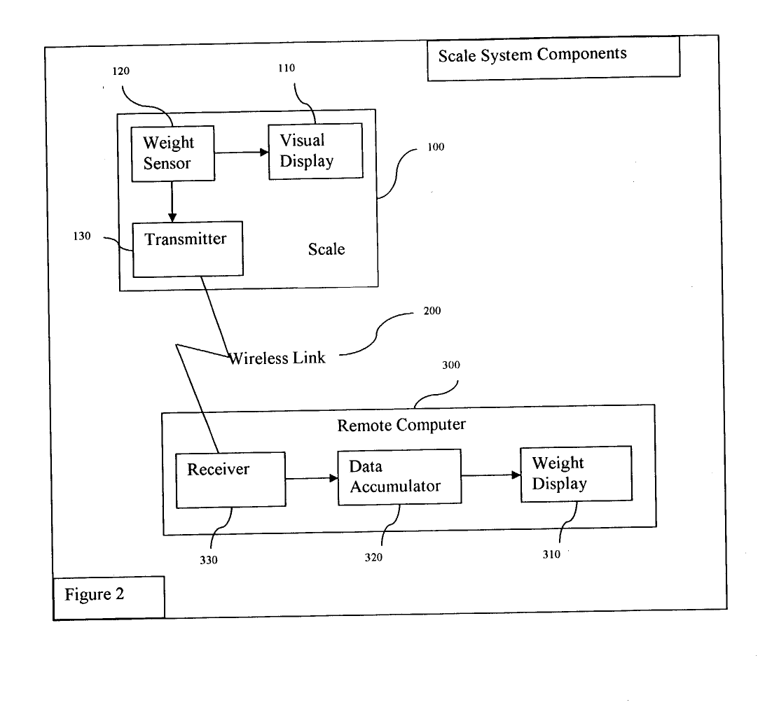

FIG. 2 illustrates the components of the scale system. Scale 100 contains weight sensor 120, which measures the individual's weight and passes the weight to visual display 110, and to transmitter 130. Transmitter 130 transmits the weight measurement to receiver 330 of remote computer 300, via wireless link 200. In remote computer 300, receiver 330 passes the weight measurement to data accumulator 320, which gathers accumulations of individuals' weight measurements and date and time of the measurement. When requested, remote computer 300 displays accumulated weight measurements for an individual via weight display 310. Weight display 310 gets the accumulated weight measurements from data accumulator 320. In the embodiment of the invention described by FIG. 2, the scale is responsible for measuring an individual's current weight measurement; the remote computer is responsible for accumulating the weight history of an individual.

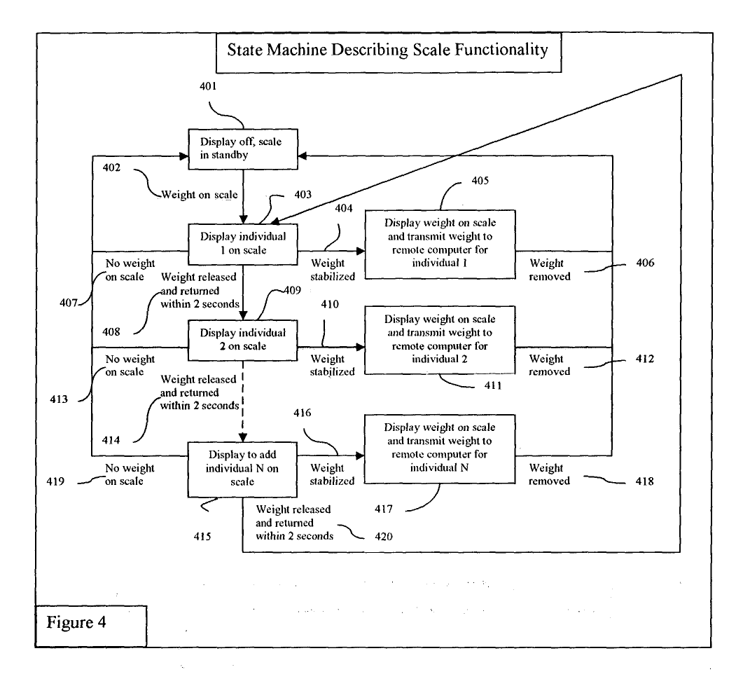

FIG. 4 is a state machine describing the functionality of the scale portion of an embodiment of this scale system. When not in use, the scale is in standby state 401, waiting for weight to be applied to the scale (402). When weight is initially placed on the scale (402), the scale enters state 403 and displays an identity for individual 1 (this may be a name or a number, or some other identifier). If the weight on the scale stabilizes (404), the scale enters state 405, displays individual 1's weight on the scale and transmits individual 1's weight to the remote computer. When weight is removed from the scale (406), the scale returns to standby state 401.

When the scale is in state 403, displaying an identity for individual 1 and weight is removed from the scale (407), the scale returns to the standby state 401 without displaying or transmitting any weight measurements. However, when the scale is in state 403 and weight is removed and returned to the scale within 2 seconds (408) (or some other timeout value), the scale transitions to state 409 and displays an identity for individual 2. As in the states for individual 1, if the weight on the scale stabilizes (410), the scale enters state 411, displays individual 2's weight on the scale and transmits individual 2's weight to the remote computer. When weight is removed (412) the scale returns to standby state 401.

When the scale is in state 409 and weight does not stabilize and is removed from the scale (413), the scale returns to standby state 401 without displaying or transmitting any weight measurements.

This state machine can continue for an arbitrary number of individuals, where, after displaying all know individuals' identities, the scale enters state 415, where it adds an identity for new individual N. As in the states for individual 1, if the weight on the scale stabilizes (416), the scale enters state 417, displays individual N's weight on the scale and transmits individual N's weight to the remote computer. When weight is removed (418) the scale returns to standby state 401.

When the scale is in state 415, displaying an identity for new individual N and weight does not stabilize and is removed from the scale (419), the scale returns to standby state 401 without displaying or transmitting any weight measurements. However if weight is removed and returned to the scale within 2 seconds (420), the scale returns to state 403 and displays the identity for individual 1, allowing the individual to reselect an existing identity.

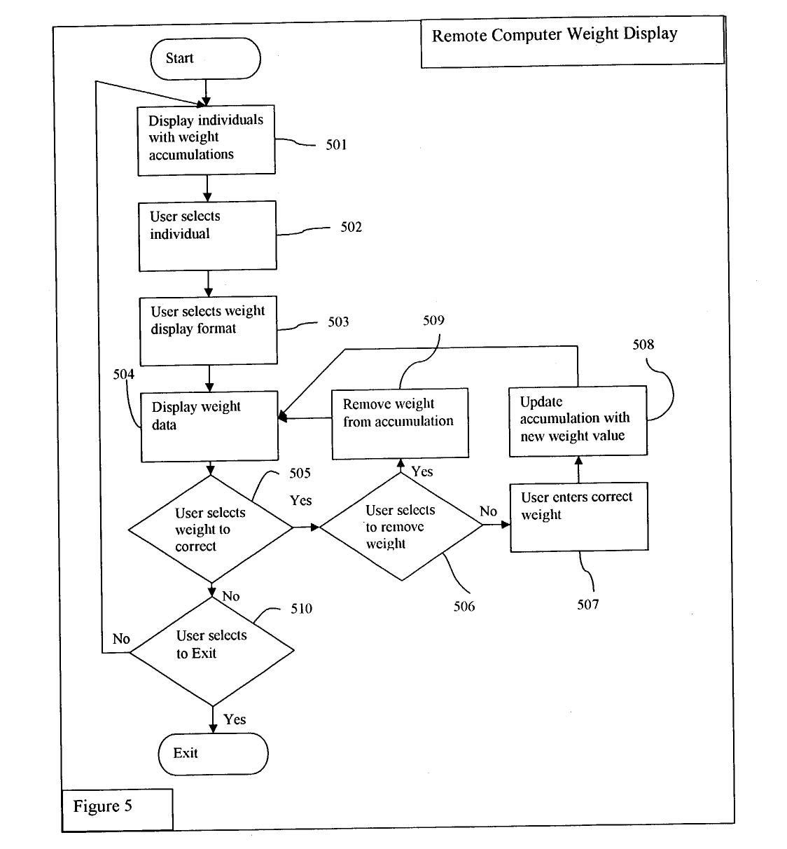

FIG. 5 illustrates a method by which an individual's weight history may be viewed on the remote computer, perhaps graphically, displaying the individual's weight versus time. The remote computer can allow manual correction of an individual's weight history by allowing selection and modification or removal of one or more of the accumulated weight measurements of an individual. In FIG. 5, the system starts by displaying the individuals with weight accumulations available for viewing (501). The user then selects an individual (502) and a format for the accumulated weight display (503). The system displays the accumulated weight measurements according to the format selected by the user (504). If the user selects to correct one or more weight measurements (505), the user may then select to remove (506) or correct a weight measurement. If the user selects to remove a weight measurement, it is removed from the accumulation of data (509), and the system redisplays the accumulated weight measurements according to the format selected by the user (504). If the user selects to correct the weight measurement (507), the selected weight measurement in the accumulation is updated (508), and the system redisplays the accumulated weight measurements according to the format selected by the user (504). If the user does not select to correct a weight measurement, the user can either select to exit (510), or can return to select a different individual to display his/her weight accumulation (501). One skilled in the art will recognize that there are many different ways this task of weight display can be performed. For example (510) may allow the user to select to exit, or to select a different individual's weight accumulation to display, or select a different format to display the current individual's weight accumulation.

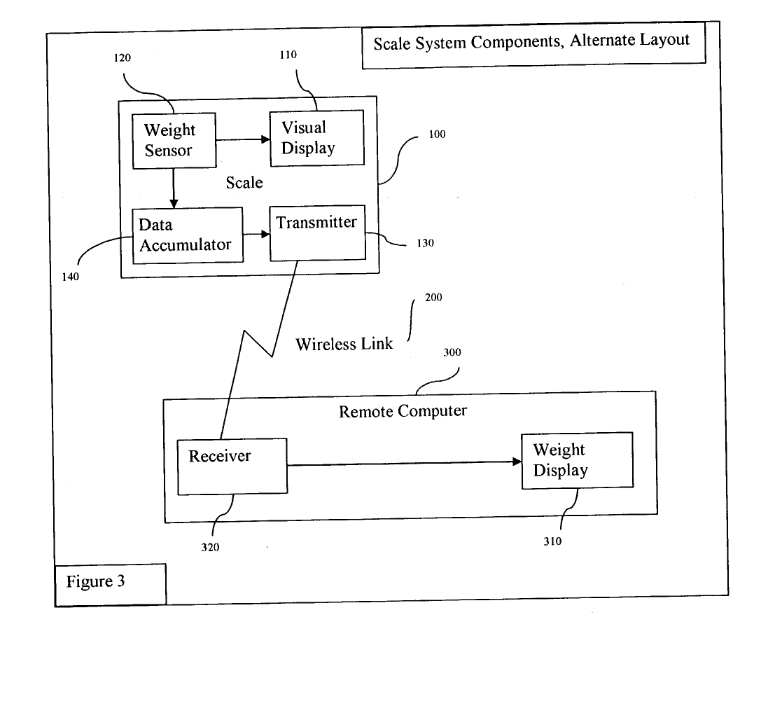

Another embodiment of this invention consists of a scale that measures the weight of an individual, displays the individual's current weight for viewing, and saves the weight measurement and the date and time of the measurement for later transmission to a remote computer (FIG. 3). In this embodiment of the invention, the scale may also contain a component that is a wireless web server. A remote computer with a similar wireless link to the web server can access the web server to provide a view of an individual's weight history. This weight history can be displayed via one or more HTML pages on a web browser on the remote computer. The wireless web server component of the scale can allow manual correction of an individual's weight history by allowing selection and modification or removal of one or more of the accumulated weight measurements of an individual. In this embodiment of the invention, the remote computer is not responsible for saving weight histories, only for displaying them. In this embodiment of the invention, a method similar to that described in FIG. 4 can be used to select which individual a weight measurement is for. This selection of an individual will also cause the current weight to be accumulated with other, previous weight measurements for that individual, not mixing them up with any other individual's weight history.

Yet another embodiment of this invention consists of a scale that measures the weight of an individual, displays the individual's current weight for viewing, and transmits the individual's weight to a remote computer. If the remote computer does not acknowledge receiving the individual's weight, the scale can save the current weight measurement and transmit it to the remote computer at a later time. In this embodiment of the invention the scale is responsible for saving an individual's weight measurement until such a time as the remote computer is ready to receive them. The remote computer is responsible for accumulating the weight history for an individual. In this embodiment of the invention, a method similar to that described in FIG. 4 can be used to select which individual a weight measurement is for. The remote computer provides a means by which weight measurements for one or more individuals may be accumulated, and as in FIG. 5, a means by which an individual's weight history can be viewed, perhaps graphically, displaying the individuals weight versus time. As in FIG. 5, the remote computer can allow manual correction of an individual's weight history by allowing selection and modification or removal of one or more of the accumulated weight measurements of an individual.

What I claim as my invention is:

1. A scale system for weighing an individual that is comprised of:
a. A scale that:
i. measures an individual's weight.
ii. displays the individual's weight on the scale.
iii. Transmits the individual's weight to a remote computer system.
b. A remote computer system that:
i. Receives the individual's weight measurements from the scale.
ii. Displays multiple instances of the individual's weight gathered versus time.

2. The scale system from claim 1 such that the individual's weight is not displayed on the scale.

3. The scale system from claim 1 or claim 2 such that an individual's weight measurements are transmitted immediately to the remote computer upon weighing of the individual.

4. The scale system from claim 1 or claim 2 such that an individual's weight measurements are stored and transmitted at a later time to the remote computer.

5. A remote computer system of claim 1 that receives the weight measurements transmitted by the scale and displays multiple instances of the individual's weight with the date and time for each measurement.

6. A remote computer system of claim 5 that displays multiple instances of the individual's weight in a graphical form.

7. The remote computer system of claim 5 that receives and accumulates the individual's weight measurements for later display.

8. The remote computer system of claim 5 that does not display weight measurements that are not consistent with previous or post measurements.

9. The remote computer system of claim 5 that allows a user to cause weight measurements that are not correct to not be displayed.

10. The scale system from claim 1 or 2 or 3 or 4 that can be used by multiple individuals, maintaining separate weight measurements and other functionality separately for all individuals.

11. The remote computer system from claim 5 or 6 or 7 or 8 or 9 that can be used by multiple individuals, maintaining separate weight measurements and other functionality for all individuals.

12. The scale system from claim 10 that allows an individual to select for which of multiple individuals the scale is performing weight measurements.

13. The remote computer system from claim 11 that allows an individual to select which of multiple individuals the scale is displaying weight measurements for.
